(19) United States
(12) Patent Application Publication
(10) Pub. No.: US 2015/0228294 A1
(43) Pub. Date: Aug. 13, 2015

(54) INFORMATION RECORDING APPARATUS, METHOD OF CONTROLLING THE SAME, AND NON-TRANSITORY COMPUTER READABLE STORAGE MEDIUM

(71) Applicant: CANON KABUSHIKI KAISHA, Tokyo (JP)

(72) Inventors: Hiroki Ito, Kawasaki-shi (JP); Keisuke Kitajima, Kawasaki-shi (JP)

(21) Appl. No.: 14/596,679

(22) Filed: Jan. 14, 2015

(30) Foreign Application Priority Data
Feb. 7, 2014 (JP) 2014-022782

(51) Int. Cl. G11B 5/024; G11B 5/09

(52) U.S. Cl. CPC G11B 5/024; G11B 5/09

(57) ABSTRACT

An information recording apparatus for recording data in a magnetic recording medium by a shingled write method, the apparatus comprises: a setting unit which sets, when the data is recorded in the magnetic recording medium, whether the data is data of a predetermined type; and a management unit which, if the data is the data of the predetermined type, records the data in an unused area out of a plurality of areas that comprise in the magnetic recording medium, and manages that the data of the predetermined type is recorded in that area, wherein the management unit, if the data of the predetermined type is deleted from the magnetic recording medium, deletes the data of the predetermined type, and manages the area to which the data of the predetermined type was recorded as an unused area.

### BACKGROUND OF THE INVENTION

1. Field of the Invention

The present invention relates to an information recording apparatus, a method of controlling the same, and a non-transitory computer readable storage medium.

2. Description of the Related Art

Conventionally, hard disks (hereinafter referred to as HDDs) are mounted as storage units within image forming apparatuses, and in addition to storing programs, HDDs realize a storage function for realizing image data saving, editing, or the like. It is estimated that in a PMR (Perpendicular Magnetic Recording) method, which is a current mainstream recording method, a limit for a recording density will be reached. Since, due to a rapid increase in the amount of information in recent years, demand for recording apparatus storage capacity is rising, an SMR (Shingled Magnetic Recording) method has been proposed as a recording method for exceeding the limit of the PMR method.

The SMR method is a recording method in which signal tracks recorded with portions of tracks that are adjacent written overlappingly as in the case of laying shingles. In the SMR method, a track group comprising a plurality of adjacent recording tracks (hereinafter referred to as a zone) is defined as a recording unit. Here, for recording of information, a random write as in the PMR method cannot be performed, and only a sequential write can be performed. In other words, upon the erasure or rewriting, with update data, a portion of the data recorded in a zone, new data is added to a vacant sector within the zone, and for an area, to which data which is the target of erasure is recorded, address information is registered in management information as an unused area. Accordingly, the actual data that is the target of the erasure is left as is in the unused area within the zone. As a consequence, when the number of zones that include an unused area increases, unused zones and zones to which addition is possible disappear, and the addition of new data becomes impossible even in a case where the HDD actually has a vacant area (an unused area). For this reason, periodic unused area cleaning processing is necessary.

Also, in the SMR method, a relationship between logical addresses and physical addresses, unlike in conventional methods, is not a one-to-one relationship, and link destinations change automatically in accordance with a disk usage condition, and address link conditions are managed by management information within the HDD.

Meanwhile, demand for security guarantees and for protection of privacy is very high, and there are cases in which there is a need for spool data and saved data recorded in a storage in an image forming apparatus to be erasable. For example, in Japanese Patent Laid-Open No. 2004-234473 and Japanese Patent Laid-Open No. 2009-093242, in the erasure of data of an HDD, so that actual data is not left, the erasure of the data is performed by overwriting the area in which the erasure target data is recorded with dummy data.

However, in a case where writing is performed from part way through a zone in which data is already written, due to the characteristics of writing overlappingly in an SMR method HDD, the data of a recording track that is adjacent by one line is overwritten. In other words, overwriting of only the data area for which the overwrite erasure is desired cannot be performed.

For this reason, upon erasure of spool data after the completion of processing in an image forming apparatus, or the like, in a case where erasure target data and save target data coexists within the same zone, it is necessary to control so as to not overwrite the save target data. More specifically, it is necessary to perform an overwrite erasure on the original zone having first performed a copy of the save target data to a separate zone. Because of this there is a problem in that erasure processing performance suffers.

### SUMMARY OF THE INVENTION

According to one aspect of the present invention, there is provided an information recording apparatus for recording data in a magnetic recording medium by a shingled write method, the apparatus comprising: a setting unit configured to set, when the data is recorded in the magnetic recording medium, whether or not the data is data of a predetermined type; and a management unit configured to, in a case where the data is the data of the predetermined type, record the data in an unused area out of a plurality of areas that comprise in the magnetic recording medium, and manage that the data of the predetermined type is recorded in that area, wherein the management unit, in a case where the data of the predetermined type is deleted from the magnetic recording medium, deletes the data of the predetermined type, and manages the area to which the data of the predetermined type was recorded as an unused area.

According to another aspect of the present invention, there is provided an information recording apparatus for recording data in a magnetic recording medium by a shingled write method, the apparatus comprising: a setting unit configured to set, when the data is recorded in the magnetic recording medium, whether or not the data is data of a predetermined type; and a management unit configured to, in a case where the data is the data of the predetermined type, record the data in any area of a plurality of areas that comprise in the magnetic recording medium, and to manage such that an addition of further data to the area, to which the data of the predetermined type is recorded, is prohibited, wherein the management unit, in a case where the data of the predetermined type is deleted from the magnetic recording medium, deletes the data of the predetermined type, and permits an addition of further data to the area to which the data of the predetermined type was recorded.

According to another aspect of the present invention, there is provided an information recording apparatus for recording data in a magnetic recording medium by a shingled write method, the apparatus comprising: a setting unit configured to set, when the data is recorded in the magnetic recording medium, whether or not the data is data of a predetermined type; and a management unit configured to, in a case where the data is the data of the predetermined type, add dummy data of a predetermined amount to the data of the predetermined type, and record in any area of a plurality of areas that comprise in the magnetic recording medium, and to manage that the data of the predetermined type is recorded in that area.

According to another aspect of the present invention, there is provided a method of controlling an information recording apparatus for recording data in a magnetic recording medium by a shingled write method, the method comprising: a setting step of setting, when the data is recorded in the magnetic recording medium, whether or not the data is data of a predetermined type; and a management step of, in a case where the data is the data of the predetermined type, recording the data in an unused area out of a plurality of areas that comprise in the magnetic recording medium, and managing that the data of the predetermined type is recorded in the area, wherein in the management step, in a case where the data of the predetermined type is deleted from the magnetic recording medium, deletes the data of the predetermined type, and manages the area to which the data of the predetermined type was recorded as an unused area.

According to another aspect of the present invention, there is provided a method of controlling an information recording apparatus for recording data in a magnetic recording medium by a shingled write method, the method comprising: a setting step of setting, when the data is recorded in the magnetic recording medium, whether or not the data is data of a predetermined type; and a management step of, in a case where the data is the data of the predetermined type, recording the data in any area of a plurality of areas that comprise in the magnetic recording medium, and managing such that an addition of further data to the area, to which the data of the predetermined type is recorded, is prohibited, wherein in the management step, in a case where the data of the predetermined type is deleted from the magnetic recording medium, the data of the predetermined type is deleted, and an addition of further data to the area to which the data of the predetermined type was recorded is permitted.

According to one aspect of the present invention, there is provided a method of controlling an information recording apparatus for recording data in a magnetic recording medium by a shingled write method, the method comprising: a setting step of setting, when the data is recorded in the magnetic recording medium, whether or not the data is data of a predetermined type; and a management step of, in a case where the data is the data of the predetermined type, adding dummy data of a predetermined amount to the data of the predetermined type, and recording in any area of a plurality of areas that comprise in the magnetic recording medium, and managing that the data of the predetermined type is recorded in that area.

According to another aspect of the present invention, there is provided a non-transitory computer-readable storage medium storing a program for causing a computer to function as an information recording apparatus for recording data in a magnetic recording medium by a shingled write method, the apparatus comprising: a setting unit configured to set, when the data is recorded in the magnetic recording medium, whether or not the data is data of a predetermined type; and a management unit configured to, in a case where the data is the data of the predetermined type, record the data in an unused area out of a plurality of areas that comprise in the magnetic recording medium, and manage that the data of the predetermined type is recorded in that area, wherein the management unit, in a case where the data of the predetermined type is deleted from the magnetic recording medium, deletes the data of the predetermined type, and manages the area to which the data of the predetermined type was recorded as an unused area.

By virtue of the present invention, in a case where erasure processing is performed for erasure target data in an SMR method magnetic recording medium, the erasure processing can be executed without greatly reducing processing speed.

Further features of the present invention will become apparent from the following description of exemplary embodiments (with reference to the attached drawings).

### BRIEF DESCRIPTION OF THE DRAWINGS

FIG. 1 is a block diagram for showing an example configuration of an image forming apparatus according to the present invention.

FIG. 2 is a block diagram for showing an internal configuration example of an HDD.

FIG. 3 is a drawing for explaining a recording method of data of an HDD of an SMR method.

FIG. 4 is a drawing for explaining normal data deletion for an HDD of an SMR method.

FIG. 5 is a drawing for explaining normal data rewriting of an HDD of an SMR method.

FIGS. 6A, 6B and 6C are drawings for explaining cleaning processing for an SMR method HDD.

FIGS. 7A, 7B, 7C and 7D are drawings for explaining erasure processing of data according to a first embodiment.

FIGS. 8A and 8B are flowcharts for data write processing of a controller unit and an HDD according to the first embodiment.

FIGS. 9A and 9B are flowcharts for data deletion processing of a controller unit and an HDD according to the first embodiment.

FIGS. 10A and 10B are conceptual diagrams of a write command packet and a data packet according to the first embodiment.

FIGS. 11A, 11B, 11C and 11D are drawings for explaining erasure processing of data according to a second embodiment.

FIGS. 12A and 12B are flowcharts for data write processing of a controller unit and an HDD according to the second embodiment.

FIGS. 13A and 13B are flowcharts for data deletion processing of a controller unit and an HDD according to the second embodiment.

FIGS. 14A, 14B and 14C are drawings for explaining a writing of data according to a third embodiment.

FIGS. 15A and 15B are flowcharts for data write processing of a controller unit and an HDD according to the third embodiment.

FIGS. 16A and 16B are drawings for explaining overwrite erasure of data according to the third embodiment.

FIGS. 17A and 17B are flowcharts for data overwrite erasure processing of a controller unit and an HDD according to the third embodiment.

FIGS. 18A, 18B, 18C and 18D are drawings for explaining a writing of data according to a fourth embodiment.

FIGS. 19A and 19B are flowcharts for data write processing of a controller unit and an HDD according to the fourth embodiment.

FIGS. 20A and 20B are drawings for explaining an overwrite erasure of data according to the fourth embodiment.

FIGS. 21A and 21B are flowcharts for data overwrite erasure processing of a controller unit and an HDD according to the fourth embodiment.

### DESCRIPTION OF THE EMBODIMENTS

Below, an explanation will be given using drawings for embodiment of the present invention. However, the configuration elements described in this embodiment are only examples, and the scope of the invention is not limited to these.

[Device Configuration]

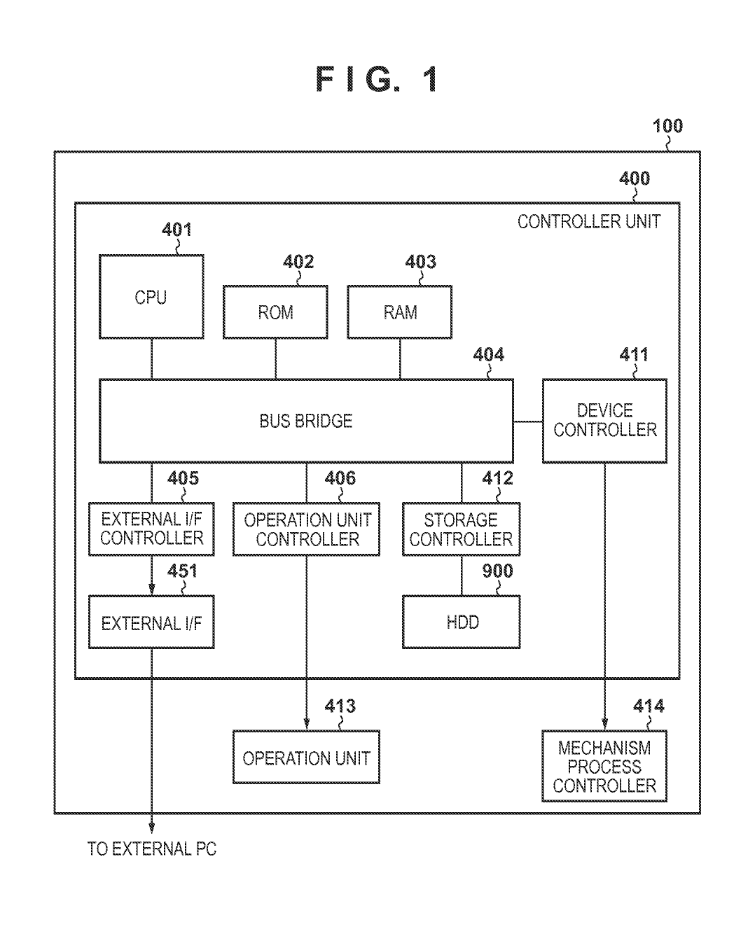

FIG. 1 is an example configuration showing hardware of an image forming apparatus 100 which is an information recording apparatus according to the present invention. A controller unit 400 performs communication with a mechanism process controller 414 based on an instruction from an operation unit 413 and an external PC (not shown) and the like, and performs overall control of the image forming apparatus 100. An external I/F 451 is an interface for connecting with the external PC (not shown). For example, the image forming apparatus 100 is connected to the external PC by an external network through the external I/F, expands print data from the external PC into an image and outputs it. Also, the image forming apparatus 100 transmits image data within a hard disk (HDD) 900 to the external computer through the external I/F 451.

The controller unit 400 comprises a CPU 401 and is controlled through an operating system (OS). The CPU 401 is connected to a bus bridge 404, and reads out an initial activation program of the CPU 401 from a ROM 402 through the bus bridge 404. Also, a RAM 403 that is used as work area for calculation accompanying control and a storage controller 412 that controls a storage device are also connected to the bus bridge 404.

The HDD 900 is a magnetic recording medium and used as a storage destination of a main program that includes the OS of the CPU 401. Other than this, the HDD 900 is used for saving image data acquired by for example, an image reader (not shown) or an external I/F 451, when editing an image by an operation unit 413, and is used as a storage destination of an application program. Also, the HDD 900 is used as a storage destination of application programs and user preference data. The HDD 900 is configured so as to be able to be accessed from the CPU 401.

Also, an external I/F controller 405 that controls the external I/F 451, which performs communication with the external network (not shown) and a USB interface (not shown), and also an operation unit controller 406, which controls the operation unit 413, are connected to the bus bridge 404. A device controller 411 is connected to the mechanism process controller 414 and is responsible for mechanism process control corresponding to each type of device. The mechanism process controller 414 controls an image reader unit (not shown) and acquires image data of an original, in the case of for example, performing copying of the original and performing printing of an image on a sheet of paper, or the like. Then, the mechanism process controller 414 controls an image print unit (not shown) and a finishing unit (not shown), and performs control of printing and print paper conveyance control. Control of printing to a sheet and control of a sheet conveyance mechanism for print processing by the image print unit and print paper discharge processing by the finishing unit is controlled by the mechanism process controller 414.

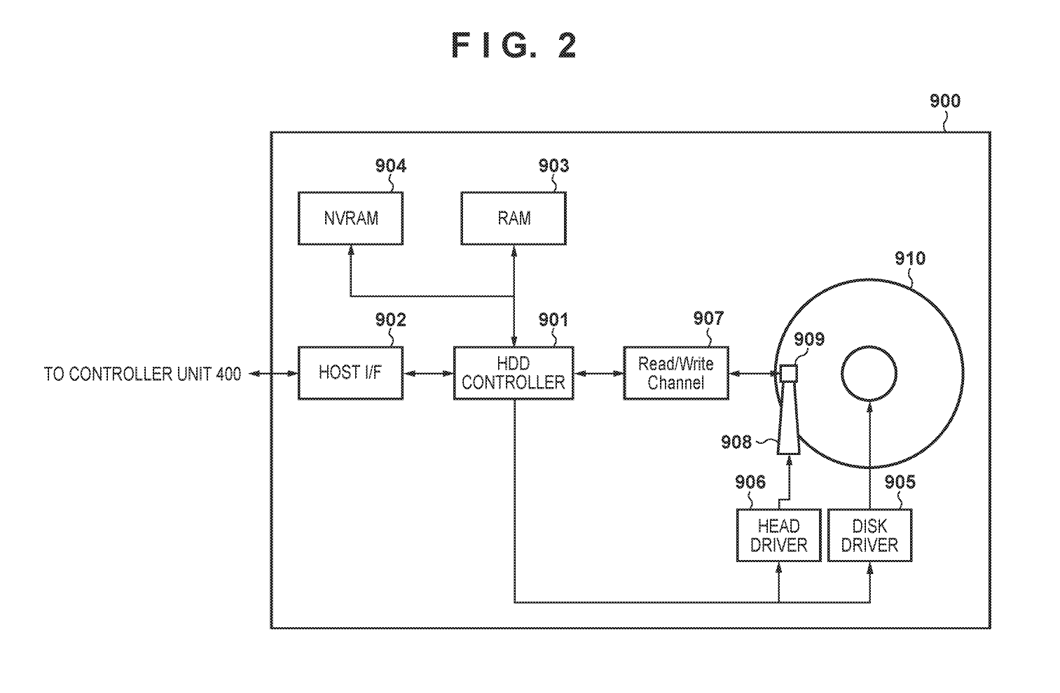

FIG. 2 shows an example of an internal configuration for the HDD 900 according to the present application invention. The HDD 900 includes an HDD controller 901, a host I/F 902, a RAM 903, an NVRAM 904, a disk driver 905, a head driver 906, a read/write signal processor 907, an arm 908, a magnetic head 909 and a magnetic disk 910. The HDD controller 901 performs overall operation control of the HDD 900, and processing and control of an input/output signal. The host I/F 902 is a module for connecting and communicating with the HDD 900 and the controller unit 400. Here, an explanation will be performed with a serial ATA (hereinafter referred to as SATA) interface in mind.

The RAM 903 is a volatile memory device that is mainly used as a work area and as a primary storage area of and reading/writing data of the HDD controller 901. The NVRAM 904 is a non-volatile memory device for storing firmware of the HDD controller 901, and recording unique data, setting values, and log data, and the like, of the HDD 900. The disk driver 905 supplies a driving signal to a spindle motor (not shown) that rotates the magnetic disk 910. The head driver 906 supplies a driving signal to a voice coil motor (not shown) to move the magnetic head 909 to a recording surface of the magnetic disk 910 via the arm 908.

The read/write signal processor(R/W Channel) 907 converts a read signal into a digital signal and outputs to the HDD controller 901. Then, data received by the host I/F 902 is input to the read/write signal processor 907 via the HDD controller 901. Then, the read/write signal processor 907 converts the inputted data into an analog signal and outputs to the magnetic head 909 via an amplifier (not shown).

The HDD 900 is managed by the HDD controller 901, and the HDD 900 holds HDD management information that records internal information of the HDD 900. The HDD management information is recorded or stored to any of the RAM 903, the NVRAM 904 or the magnetic disk 910 that the HDD 900 comprises, or to a plurality of the recording mediums. Note, since information that is stored to the RAM 903 disappears upon a power shutdown, it is necessary to use both the NVRAM 904 which is a nonvolatile recording medium and the magnetic disk 910. Also, besides HDD management information, FS management information for performance of OS file system management by the controller unit 400 is recorded and stored on the magnetic disk 910.

[Explanation of SMR Method]

In the HDD 900 according to the embodiment, an SMR method (a shingled write method) is applied for recording of information to the recording surface of the magnetic disk 910. First, an explanation will be briefly given concerning the data recording method of the SMR method.

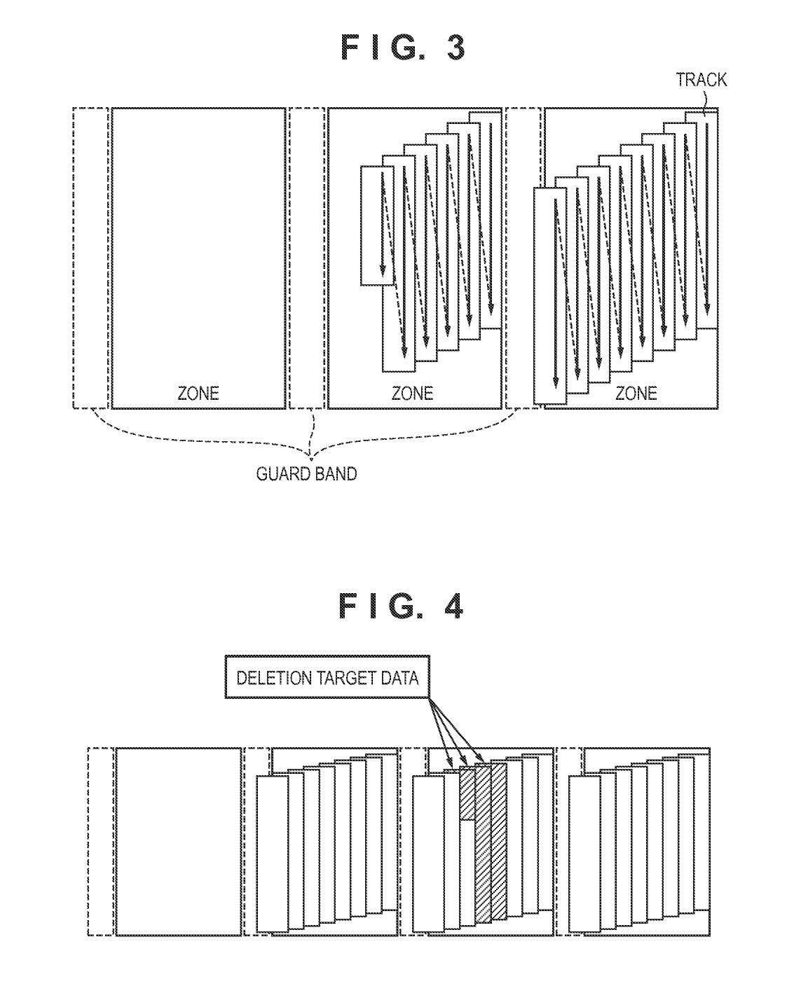

In the SMR method, as shown in FIG. 3, in a recording area, recording is performed in sequential writing by overlapping parts of tracks that are adjacent in units of zones. Therefore, in the case of an overwrite (overwriting) of a track that is part way through within a zone, the overwrite of the track that is part way through alone cannot be performed, and the overwrite is only possible in units of the zone. Between zones, a guard band is arranged for prevention of interference between tracks that in adjacent zones.

In the SMR method, unlike in conventional art (for example, the PMR method), logical addresses and physical addresses do not have a one-to-one relationship, and these dynamically change based on usage conditions of the magnetic disk 910. Therefore, link information of a physical address and a logical address are recorded and stored to HDD management information that is managed by the HDD controller 901.

Next, an explanation will be given for a method of normal erasing and updating of data through the SMR method. In the case of erasing a part of data within a zone as shown in FIG. 4, registration as an unused area of address information of the erasure target data in FS management information and HDD management information respectively is performed.

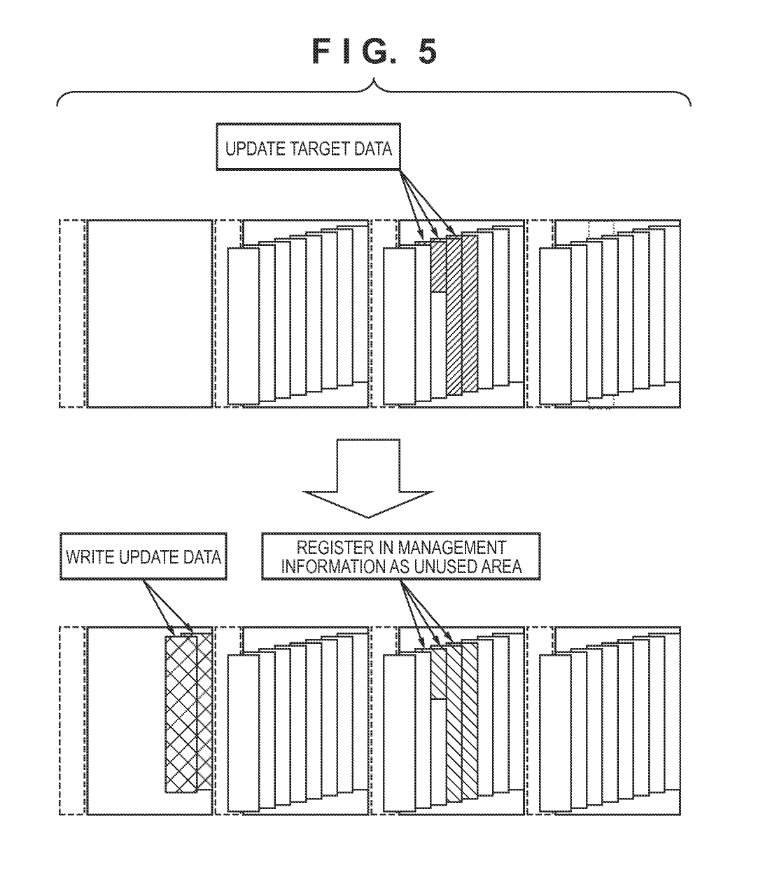

Also, in the case of rewriting a part of data within a zone, as shown in FIG. 5, update data is added to a vacant sector, and for data before updating, an address is registered in each type of management information as an unused area similar to when data is erased. Therefore, in both the cases of erasure processing and updating processing, only each type of management information is updated, and erasure target data and actual data before updating within a zone remain as is within the zone.

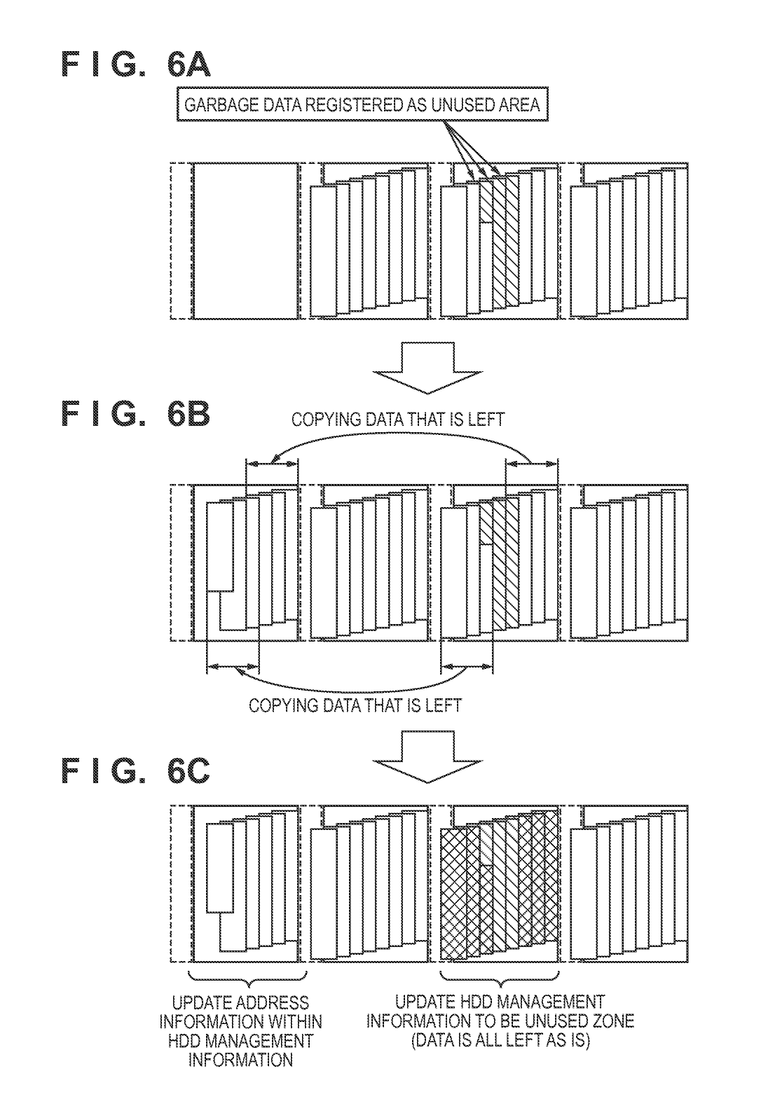

As a result of repeatedly erasing and updating a part of data within a zone, zones that include an unused area accumulate as in FIGS. 4 and 5. Since for a zone that includes an unused area, overwrite cannot be performed only to tracks of the unused area due to the characteristics of the SMR method, it becomes a vacant area that is impossible to write. Here, in order to free a zone that includes an unused area that is impossible to write to, it is necessary to perform cleaning processing at regular intervals as shown in FIGS. 6A-6C.

For a zone that includes garbage data as shown in FIG. 6A, data within the zone that is to be left is copied, as shown in FIG. 6B, to another zone that is usable. After completion of copying of data that is to be left, as shown in FIG. 6C, address information of the new storage location of the data to be left is registered to the HDD management information, and registration of the zone that includes the garbage data as an unused zone (in other words, the zone becomes useable) is performed in the HDD management information. Even in this case, all data within the zone that is been designated as an unused zone will remain as is until writing of new data within the zone is performed.

### First Embodiment

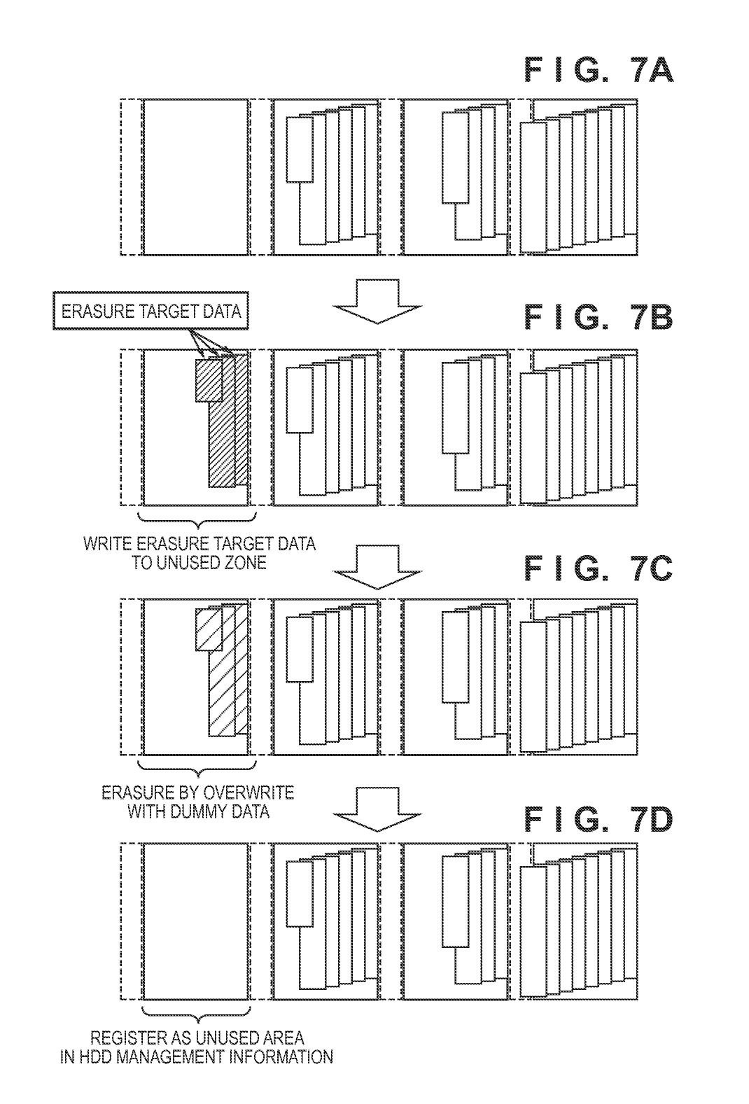

Below, a detailed explanation will be given for operation of data erasure in the HDD 900 as applied to the present invention. In ATA and SATA, which are interfaces for a general storage device, commands that correspond to functions for erasure and deletion do not exist. Therefore, erasure processing according to the present embodiment is assumed to be performed as an extension of a write command FIGS. 7A-7D are conceptual diagrams for explaining erasure processing of data according to the first embodiment.

(Data Write Processing)

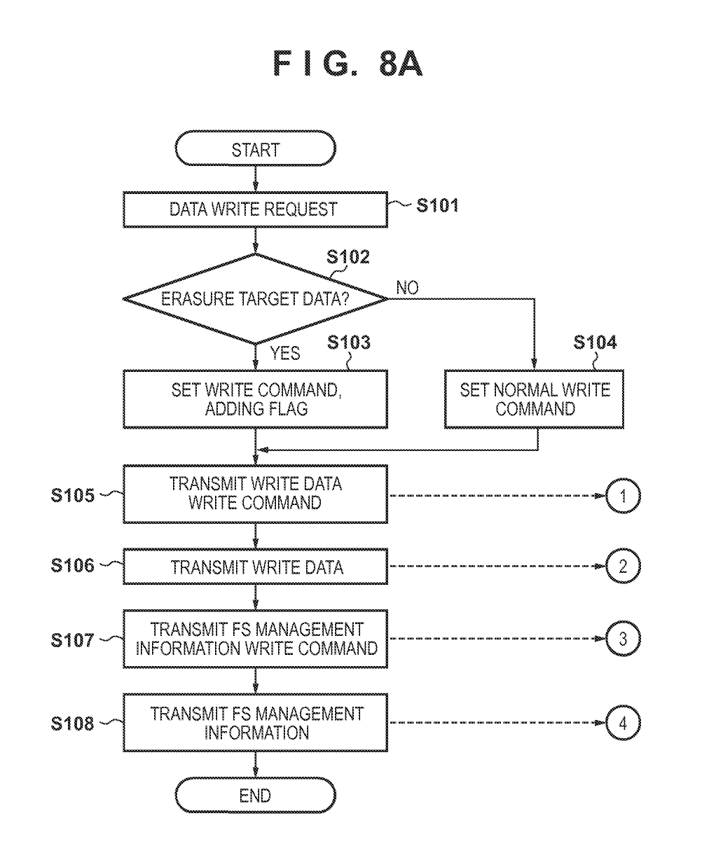

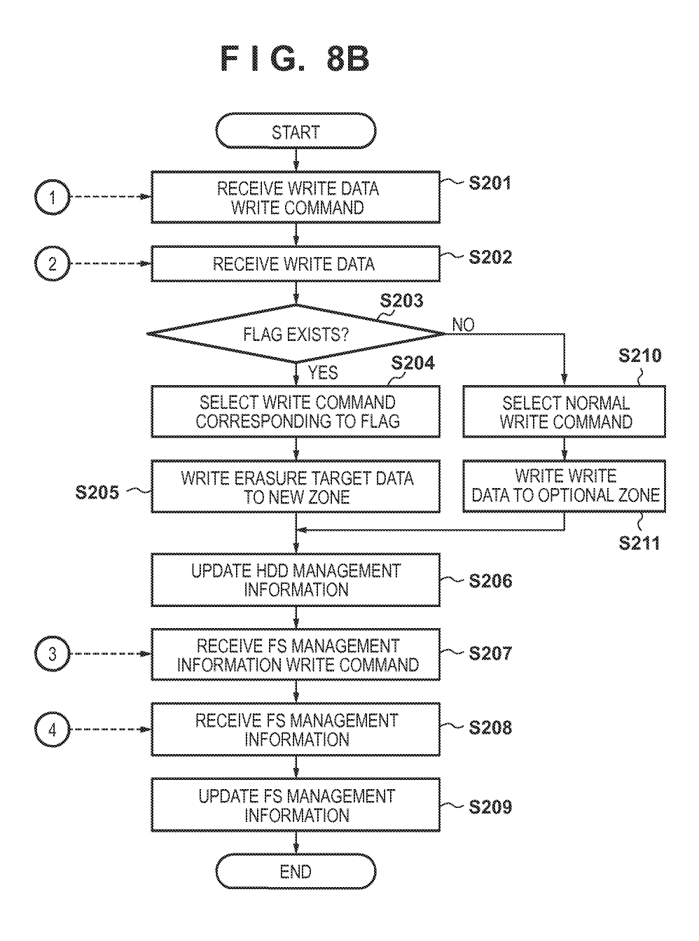

FIGS. 8A and 8B show processing of each of the controller unit 400 and the HDD 900 for data write processing according to the embodiment, and the broken line arrows in FIGS. 8A and 8B show transmission/reception of data between the subjects.

FIG. 8A is a flowchart of write processing within the controller unit 400 that is connected to the HDD 900 in FIGS. 7A-7D.

For FIG. 7A, once a write request of data towards the HDD 900 by the OS is made (step S101), the CPU 401 confirms whether or not the data to be written is data that is erasure target data (step S102). “erasure target data”, which will be discussed below, corresponds to for example, data such as a temporary file and spool data which has become unnecessary in accordance with a completion of processing, and is deleted successively. Note, the erasure target data is not limited to this, and data for which long duration storage is unnecessary, and the like, and predetermined types of data may be a target as well.

In the case that write data is the erasure target data (Yes at step S102), processing will proceed to step S103. At step S103, the CPU 401, for a data write instruction that is transmitted to the HDD 900 through the storage controller 412, sets a value that is defined in advance as erasure flag data, in a predetermined area provided within the instruction. With regards to the predetermined area, it is defined by the format of the instruction, and a configuration may be taken such that it is ignored for a device other than that corresponding to the configuration of the present invention.

In the case that write data is not erasure target data (No at step S102), the CPU 401 transmits a data write instruction to the HDD 900 and sets a normal data write instruction in step S104.

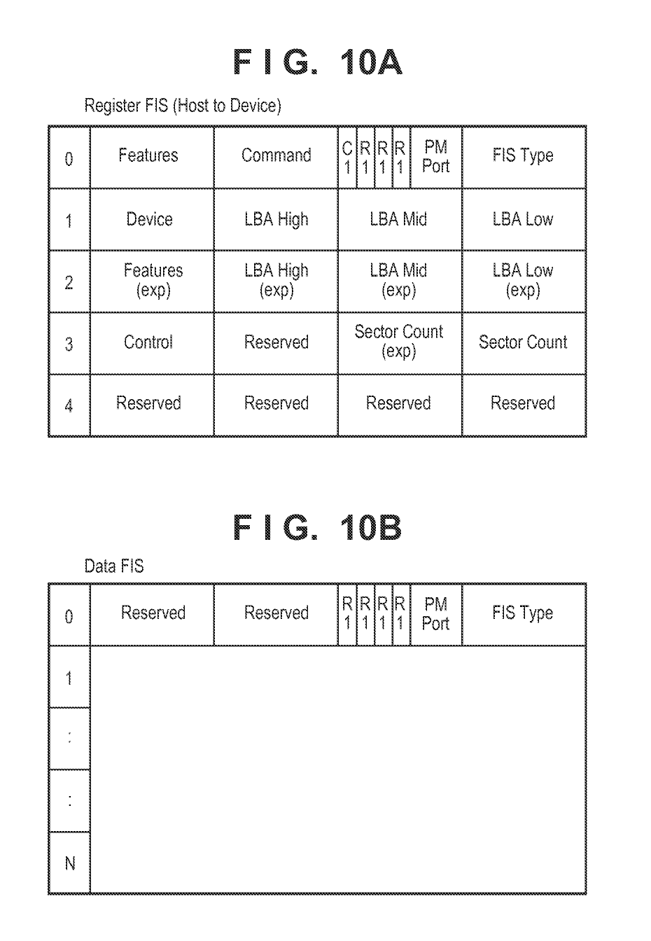

For step 5105, the CPU 401 transmits a write command for write data that was set in step S103 or in step S104 to the HDD 900. Furthermore, at step S106, the CPU 401, transmits write data to the HDD 900. As an example of a write command, a command packet of a SATA standard of an ATA standard (Registers FIS: Frame Information Structure) as shown in FIG. 10A is used. Also, as an example of write data, a data packet of a SATA standard or an ATA standard (Data FIS) as shown in FIG. 10B is used.

A features register on an FIS of FIG. 10A corresponds as an example of a predetermined area for setting erasure flag data. Note, besides a validity/invalidity of erasure processing according to the present embodiment, a selection of write instruction (rewriting/erasing), a selection of overwrite data, and a setting of the number of times of overwriting, and the like, may also be implemented for the erasure flag data that is set to the feature register. For the present embodiment, it is assumed that at least a flag indicating that erasure processing, according to the embodiment, is valid is set.

At step S107, the CPU 401 transmits a normal write command to the HDD 900 in order to perform file system updating. Furthermore, at step S108, the CPU 401 transmits, to the HDD 900, FS management information update data such as logical address information of data to be written. This processing flow is then terminated.

FIG. 8B is a flowchart for write processing within the HDD 900 for FIGS. 7A-7D. At step S201, the HDD controller 901 receives the data write instruction that is transmitted from the controller unit 400 at step S105 via the host I/F 902. At step S202, the HDD controller 901 receives the write data of data that is transmitted from the controller unit 400 at step S106 via the host I/F 902. At step S203, the HDD controller 901 confirms whether or not the erasure flag data, that represents that erasure processing according to the embodiment is valid, is set within the data write instruction.

In the case that the erasure flag data is detected (Yes at step S203), the HDD controller 901 selects a write command that corresponds to the erasure flag data at step S204. Here, a write command of a write mode that corresponds to erasure processing of the present embodiment is selected. At step S205, as in FIG. 7B, the HDD controller 901 writes erasure target data that is received from the storage controller 412 of the controller unit 400 to the new vacant zone (unused zone) on the magnetic disk 910 of the HDD 900.

In the case that the erasure flag data is not detected (No at step S202), the HDD controller 901 selects a normal write command at step S210. At step S211, the HDD controller 901 performs writing of data to an optional zone in normal write processing.

At step S206, the HDD controller 901 performs updating of storage location address information for an address that was written at step S205 or step S211 in the HDD management information. At step S207, the HDD controller 901 receives the write command transmitted from the controller unit 400 at step S107. At step S208, the HDD controller 901 receives FS management information that includes logical address information of write data by the controller unit 400 at step S108. At step S209, the HDD controller 901 updates the FS management information on the magnetic disk 910 based on the FS management information received from the controller unit 400 at step S208. This processing flow is then terminated.

(Data Deletion Processing)

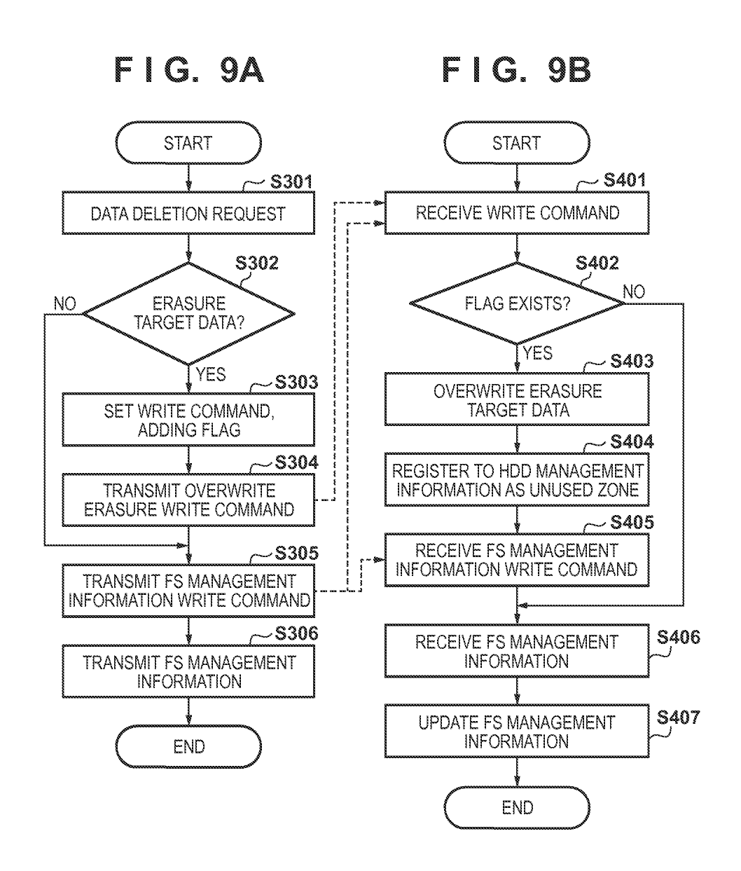

FIGS. 9A and 9B show processing of each of the controller unit 400 and the HDD 900 for data deletion processing according to the embodiment, and the broken line arrows in FIGS. 9A and 9B show transmission/reception of data between the subjects.

FIG. 9A is a flowchart for data deletion processing within the controller unit 400 that is connected to the HDD 900 in FIGS. 7A-7D.

For FIG. 7B, once a data deletion request towards the HDD 900 by the OS is made (step S301), the CPU 401 confirms whether or not the data to be deleted is data that is erasure target data (step S302).

In the case that deletion data is erasure target data (Yes at step S302), for a data write instruction that is to be transmit to the HDD 900, the CPU 401 sets, as erasure flag data, a value defined in advance, in a predetermined area arranged within the instruction, at step S303. For the present embodiment, a flag is set that shows that at least erasure processing according to the embodiment is “enabled”, and the selection of the write instruction is for “overwrite erasure mode”. At step S304, the CPU 401 transmits, to the HDD 900, the write instruction for overwrite erasure that was set at step S303, and the processing advances to step S305.

On the other hand, in the case that the deletion data is not erasure target data (No at step S302), the processing advances to step S305. At step S305, the CPU 401 transmits a normal write command to the HDD 900 in order to update the file system for the HDD 900 and performs data deletion. Furthermore, at step S108, the CPU 401 transmits, to the HDD 900, FS management information update data such as logical address information for the deletion data. This processing flow is then terminated.

FIG. 9B is a flowchart for data deletion processing within the HDD 900 for FIGS. 7A-7D. At step S401, the HDD controller 901 receives a data write instruction that is transmitted from the controller unit 400 via the host I/F 902. At step S402, the HDD controller 901 confirms whether or not erasure flag data that represents that an overwrite erasure mode according to the embodiment within the data write instruction is set.

In the case that erasure flag data is detected (Yes at step S402), at step S403 the HDD controller 901 performs erasure processing by overwriting the erasure target data with dummy data, as in FIG. 7C. For overwrite erasure processing, execution is performed wherein the type and number of times of overwriting of write data (dummy data) when performing the overwriting are in accordance with the flag information set at step S304 of FIG. 9A. Note that, the dummy data used in the embodiment hereinafter is added by the controller unit 400, and regarding the contents of the data, optional data may be randomly generated, and fixed data may be generated as well. At step S404, the HDD controller 901, as in FIG. 7D, performs registration as an unused zone in the HDD management information of a zone for which the overwriting processing was performed. At step S405, the HDD controller 901 receives FS management information that includes a normal write command and logical address information of the erasure target data transmitted by the controller unit 400.

On the other hand, in the case that the erasure flag data is not detected (No at step S402), since a normal write command is received, the processing transitions to step S406. In this case, the write target of the normal write command is FS management information.

At step S406, the HDD controller 901 receives FS management information that includes the normal write command and logical address information of the erasure target data transmitted by the controller unit 400. At step S407, the HDD controller 901 updates the FS management information on the magnetic disk 910 based on the FS management information received at step S406.

With the above, in the case of performing erasure processing for erasure target data, it is no longer required to perform copying of saved data by not mixing erasure target data and saved data within the same zone. For this reason, it is possible for an HDD of the SMR method to achieve performance as if it were performing erasure processing on a conventional type of HDD.

### Second Embodiment

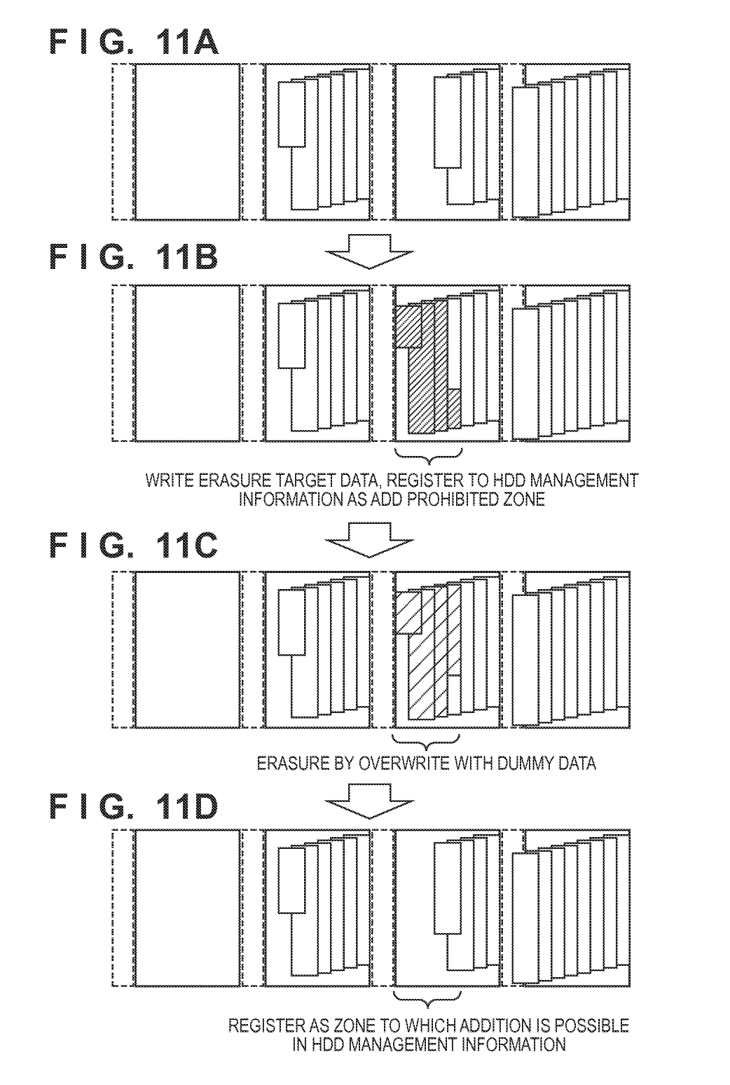

FIGS. 11A-11D are conceptual diagrams for explaining erasure processing of data according to the second embodiment.

(Data Write Processing)

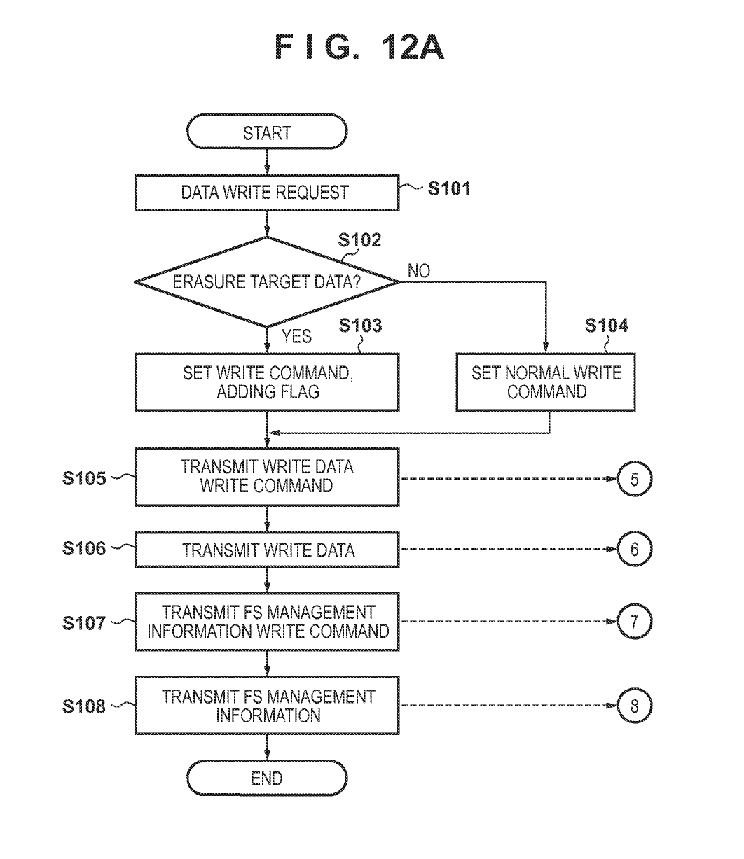

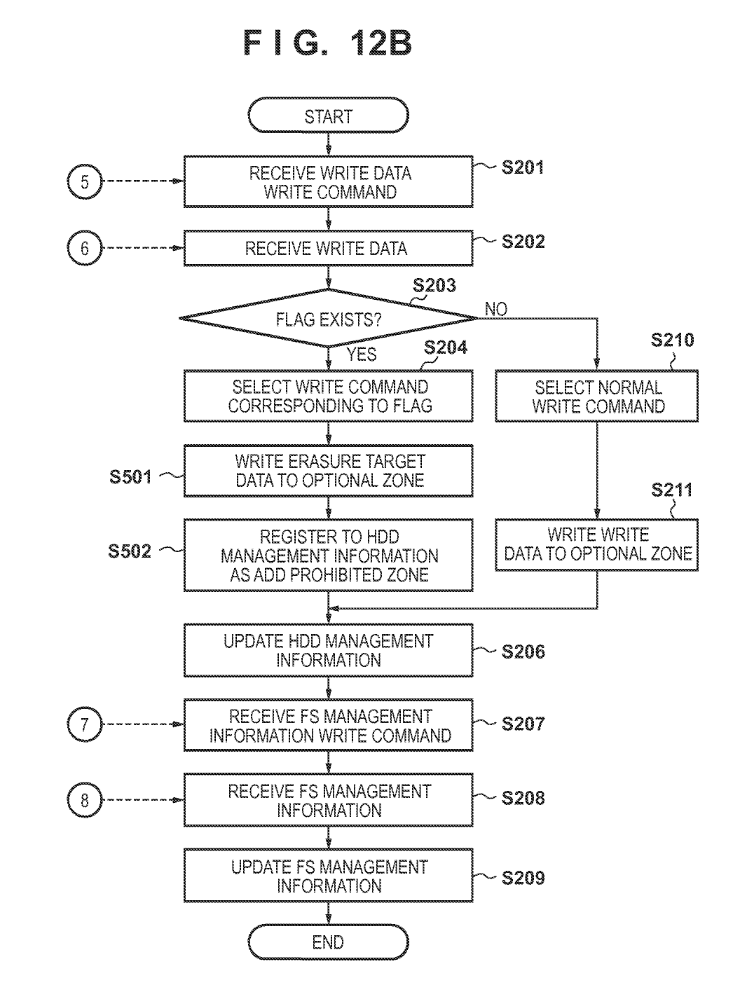

FIGS. 12A and 12B show processing of each of the controller unit 400 and the HDD 900 for data write processing according to the embodiment, and the broken line arrows in FIGS. 12A and 12B show transmission/reception of data between the subjects. FIG. 12A is a flowchart for write processing on the controller unit 400 side for FIGS. 11A-11D. Note, because the content of processing of step S101-step S108 of FIG. 12A is the same as that of step S101-step S108 of FIG. 8A, a detailed explanation is omitted.

FIG. 12B is a flowchart for write processing within the HDD 900 for FIGS. 11A-11D. Note, because the content of processing of step S201-step S203 and step S206-step S211 of FIG. 12B, is the same as that of step S201-step S203 and step S206-step S211 of FIG. 8B, a detailed explanation is omitted.

After processing at step S204, as in FIG. 11B, at step S501, the HDD controller 901 performs writing of erasure target data that is received from the storage controller 412 of the controller unit 400 to an optional zone on the magnetic disk 910 of the HDD 900. Here, an “optional zone” may be a new unused zone or a zone to which addition is possible. FIGS. 11A-11D show an example for a case of using a zone to which addition is possible.

At step S502, the HDD controller 901, as in FIG. 11B, registers a zone in which erasure target data was written at step S201 as an add prohibited zone in the HDD management information. After this, processing advances to step S206.

(Data Deletion Processing)

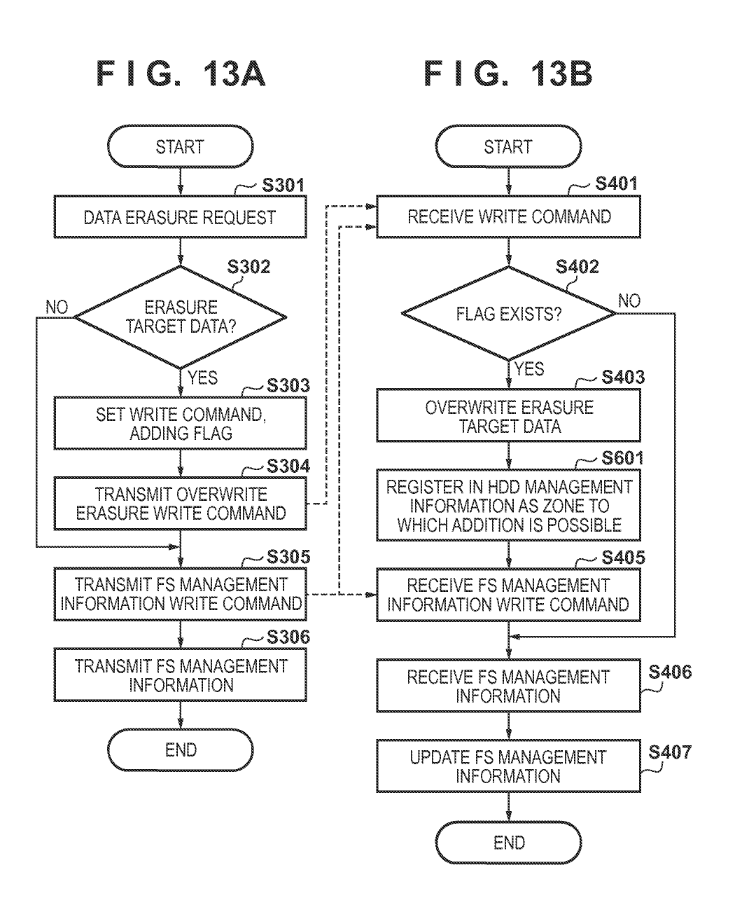

FIGS. 13A and 13B show processing of each of the controller unit 400 and the HDD 900 for the data deletion processing according to the embodiment, and the broken line arrows in FIGS. 13A and 13B show transmission/reception of data between the subjects. FIG. 13A is a flowchart of data deletion processing on the controller unit 400 side for FIGS. 11A-11D. Since the content of processing of step S301-step S306 of FIG. 13A is the same as that of step S301-step S306 of FIG. 9A, a detailed explanation is omitted.

FIG. 13B is a flowchart for data deletion processing within the HDD 900 for FIGS. 11A-11D. Note, since the content of processing of step S401-step S403 and step S405-step S407 of FIG. 13B is the same as that of step S401-step S403 and step S405-step S407 of FIG. 9B, a detailed explanation is omitted. Note, in the present embodiment, as in FIG. 11C, at step S403, overwrite erasure by dummy data is performed for an optional zone registered in the HDD management information.

After the processing of step S403, the HDD controller 901, as in FIG. 11D, at step S601, performs registration, as a zone for which addition is possible, in the HDD management information of a zone in which overwriting processing was performed. In other words, the HDD controller 901 permits adding to the zone for which adding was prohibited. After this, processing advances to step S405.

With the above, in the case of performing erasure processing for erasure target data, there is even less necessity to perform copying of saved data, or the like, even in a case where there is no usable zone, compared to the first embodiment. For this reason, it is possible to achieve performance as if performing erasure processing on a conventional type of HDD without performing copying of saved data.

### Third Embodiment

(Data Write Processing)

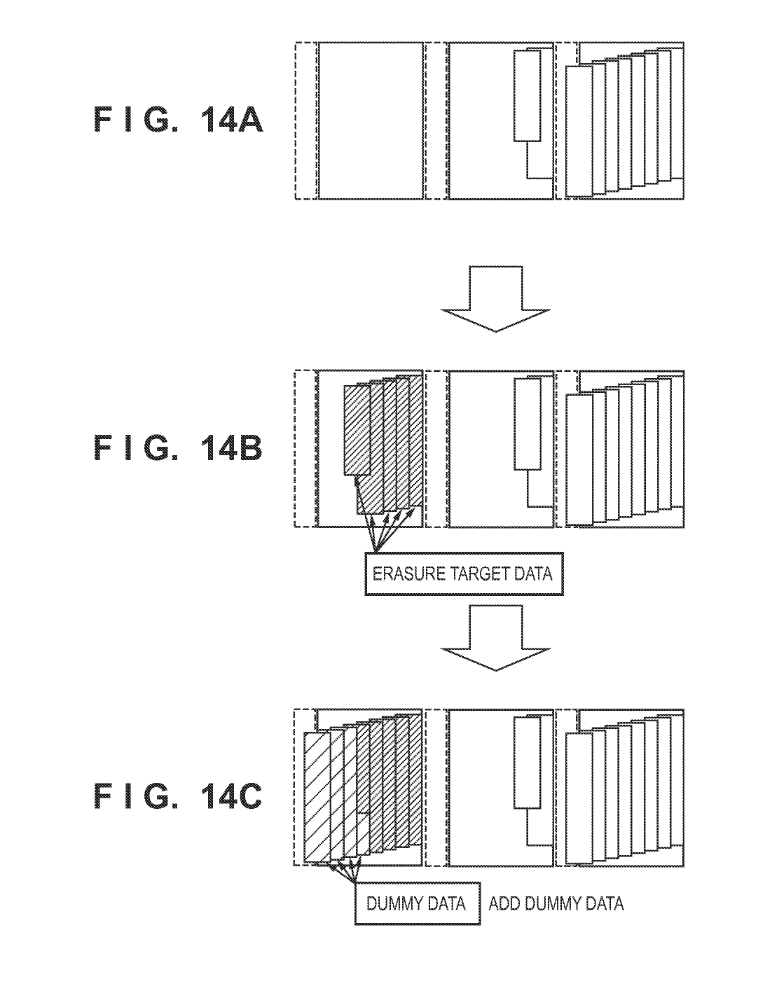

FIGS. 14A-14C are conceptual diagrams for explaining data write processing according to a third embodiment. FIG. 14A shows the HDD 900 in a state before being written to. Also, FIG. 14B shows a state in which erasure target data has been written to a new zone, and FIG. 14C shows a later state in which dummy data is written to an area remaining within a zone to which the erasure target data was written.

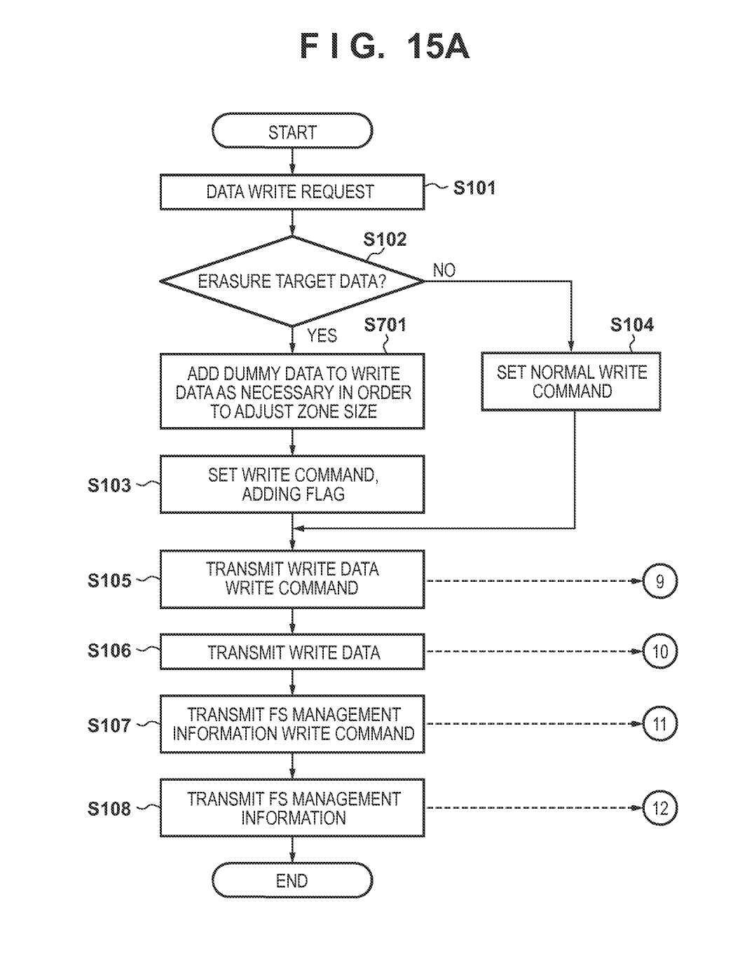

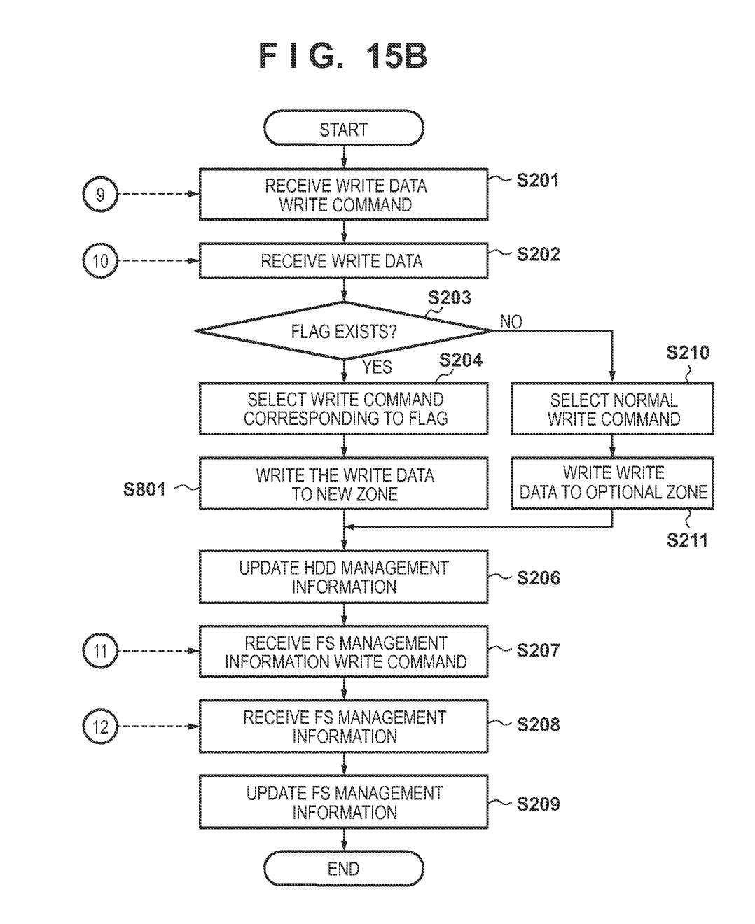

FIGS. 15A and 15B show processing of each of the controller unit 400 and the HDD 900 for the data write processing according to the embodiment, and the broken line arrows in FIGS. 15A and 15B show transmission/reception of data between the subjects. FIG. 15A is a flowchart for the write processing within the controller unit 400 that is connected to the HDD 900 in FIGS. 14A-14C. Note, because the content of processing of step S101-step S108 of FIG. 15A is the same as that of step S101-step S108 of FIG. 8A, a detailed explanation is omitted.

In the case that the write data is erasure target data (Yes at step S102), the CPU 401, at step S701, performs an alignment adjustment of a target data size such that the size that is to be written to the HDD 900 is a zone size unit. Data that is insufficient is added as dummy data as in FIG. 14C. After this, processing advances to step S103.

FIG. 15B is a flowchart for write processing within the HDD 900 for FIGS. 14A-14C. Note, because step S201-step S204 and step S206-step S211 of FIG. 15B are the same as step S201-step S204 and step S206-step S211 of FIG. 8B, a detailed explanation is omitted.

After processing at step S204, the HDD controller 901, at step S801, as in FIG. 14B, performs writing of erasure target data that is received from the storage controller 412 to a new zone on the magnetic disk 910 of the HDD 900. Note that, in step S701, since alignment to the zone size is obtained for the erasure target data, actually writing of data is performed as in FIG. 14C. After this, the processing advances to step S206.

(Data Deletion Processing)

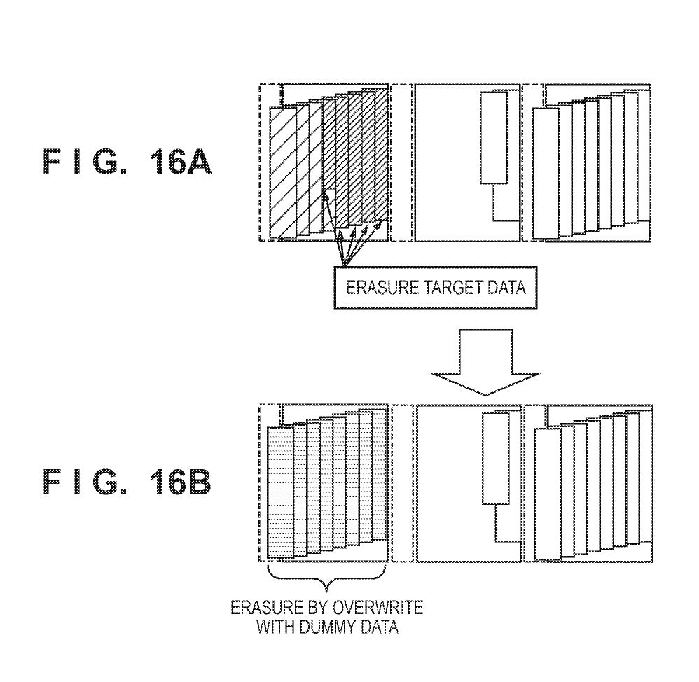

FIGS. 16A and 16B are conceptual diagrams for explaining data deletion processing according to the third embodiment. FIG. 16A shows a state in which erasure target data and the dummy data due to the alignment adjustment are written to a particular zone of the HDD 900 by the processing of FIGS. 15A and 15B. Also, FIG. 16B shows a state in which overwrite erasure dummy data is written in that zone.

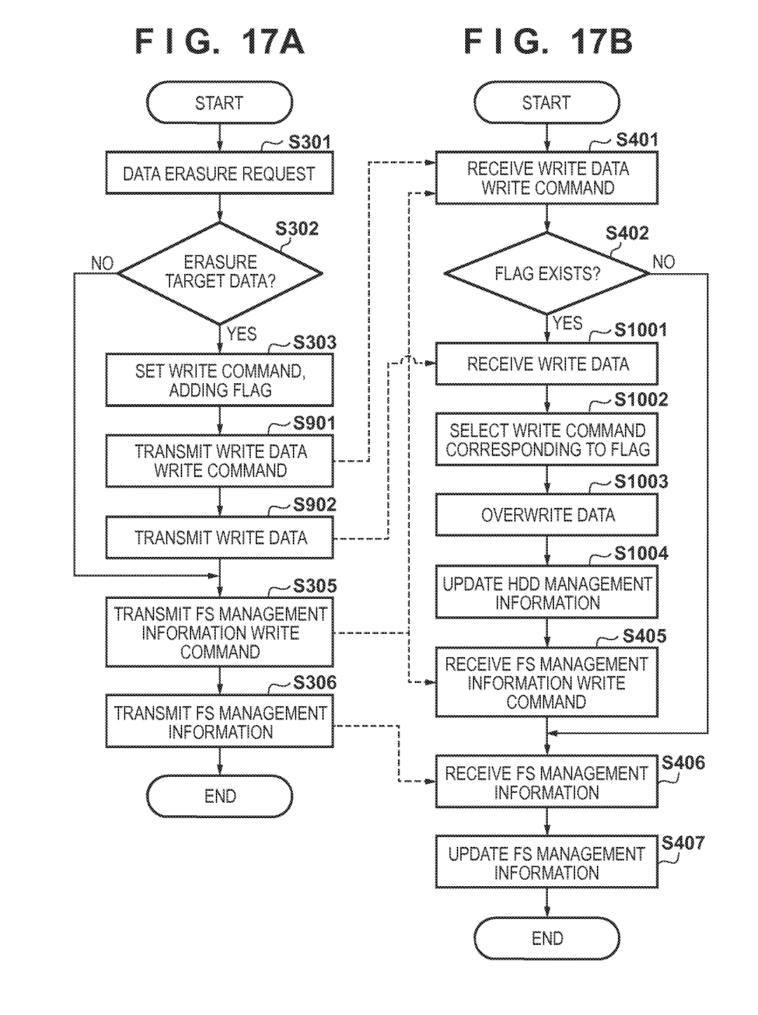

FIGS. 17A and 17B show processing of each of the controller unit 400 and the HDD 900 for the data deletion processing according to the embodiment, and the broken line arrows in FIGS. 17A and 17B show transmission/reception of data between the subjects. FIG. 17A is a flowchart of data erasure processing within the controller unit 400 that is connected to the HDD 900 in FIGS. 16A and 16B. Note, since the content of processing of step S301-step S303 and step S305-step S306 of FIG. 17A is the same as that of step S301-step S303 and step S305-step S306 of FIG. 9A, a detailed explanation is omitted.

After processing of step S303, at step S901, the CPU 401 transmits, to the HDD 900, a write data write command that was set in step S303. After this, at step S902, the CPU 401 transmits write data to the HDD 900. After this, processing advances to step S305.

FIG. 17B is a flowchart for data deletion processing within the HDD 900 for FIGS. 16A and 16B. Note, since the content of processing of step S401-step S402 and step S405-step S407 of FIG. 17B is the same as that of step S401-step S402 and step S405-step S407 of FIG. 9B, a detailed explanation is omitted.

In the case that the erasure flag data is detected (Yes at step S402), the HDD controller 901, at step S1001, receives write data transmitted from the controller unit 400 in step S902 of FIG. 17A via the host I/F 902. At step S1002, the HDD controller 901 selects a write command corresponding to the erasure flag data. Here, a write command corresponding to an overwrite erasure mode is selected. At step S1003, the HDD controller 901 executes an overwrite of data that has been written. Note that, in the present embodiment, for erasure target data, alignment is adjusted to the zone size, and data will not overflow from a zone in when overwriting is executed. At step S1004, the HDD controller 901 performs updating of storage location address information for an address that was written at step S1003 in the HDD management information. After this, processing advances to step S405.

Therefore, since erasure target data is saved in zone size units, overwrite erasure is executable as is without influencing an adjacent track. For this reason, it is possible for an SMR method HDD to achieve performance as if erasure processing were performed on a conventional type of HDD.

### Fourth Embodiment

(Data Write Processing)

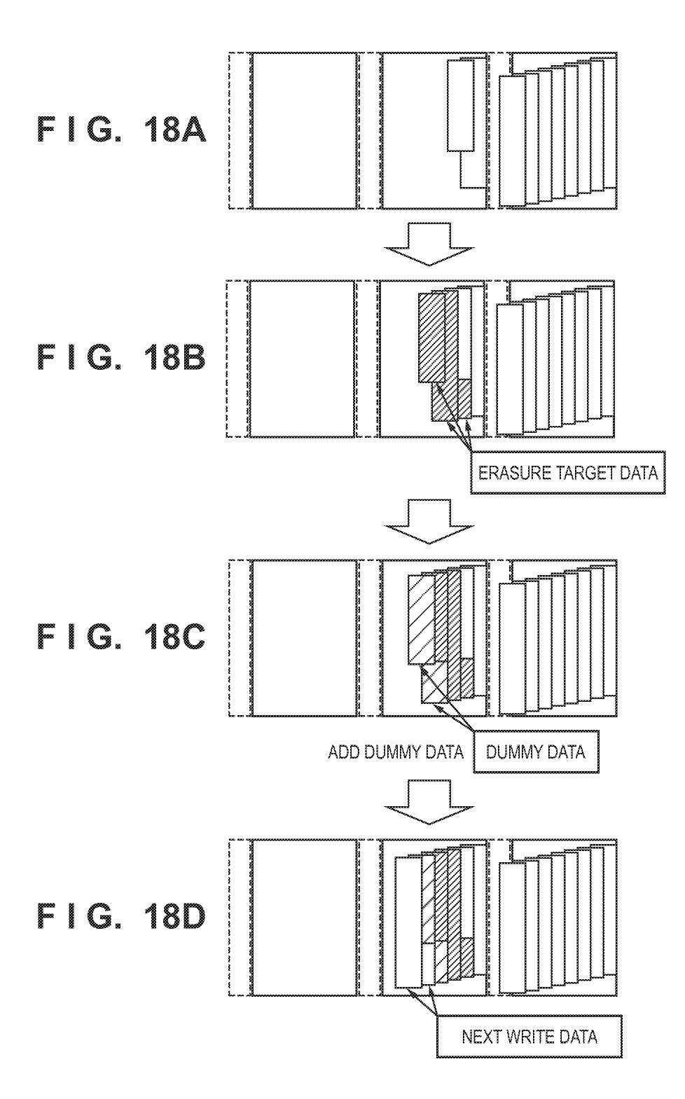

FIGS. 18A-18D are conceptual diagrams for explaining data write processing of according to a fourth embodiment. FIG. 18A shows the HDD 900 in a state before being written to. Also, FIG. 18B shows a state in which erasure target data is added to a zone that is being updated, FIG. 18C shows a later state in which dummy data has been written, and FIG. 18D shows a state in which the next received write data item has been written.

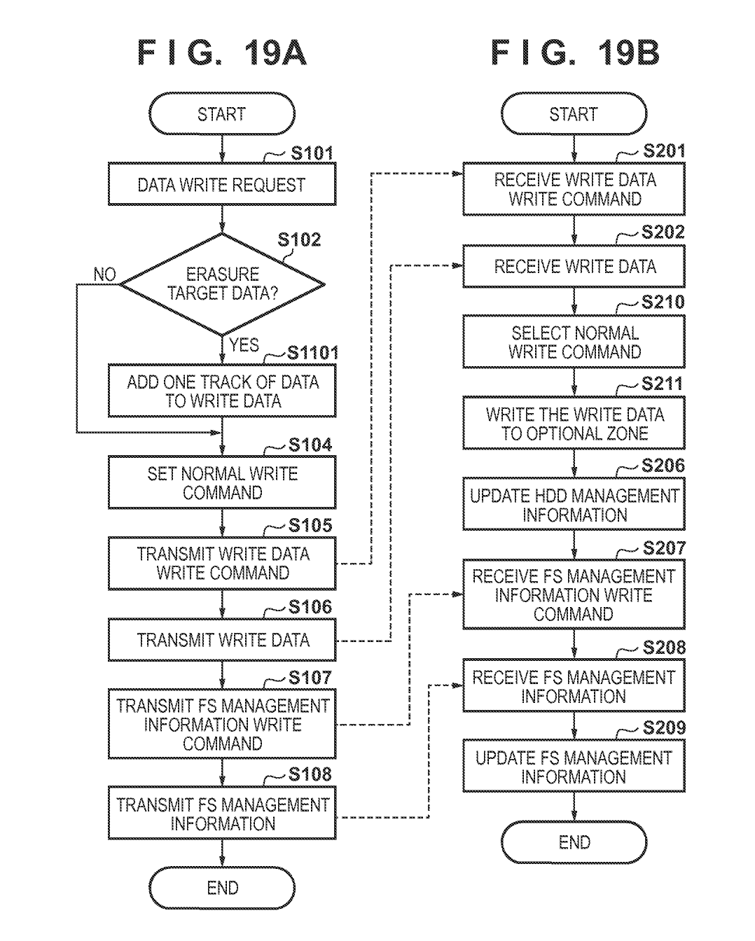

FIGS. 19A and 19B show processing of each of the controller unit 400 and the HDD 900 for the data write processing according to the embodiment, and the broken line arrows in FIGS. 19A and 19B show transmission/reception of data between the subjects. FIG. 19A is a flowchart of write processing within the controller unit 400 that is connected to the HDD 900 in FIGS. 18A-18D. Note, since the content of processing of step S101-step S102 and step S104-step S108 of FIG. 19A are the same as step S101-step S102 and step S104-step S108 of FIG. 8A, a detailed explanation is omitted.

In the case that write data is erasure target data (Yes at step S102), the CPU 401 adds, at step S1101, one track of dummy data for a write size of the erasure target data. At this time, the CPU 401 holds a size of one track that corresponds to the connected HDD in the device beforehand, and the CPU 401 performs a determination as to a size of one track by using this. Because of this, dummy data is added to an adjacent track of the erasure target data as shown in FIG. 18C. In other words, by adding dummy data, data overlapping between the erasure target data and data that is to be written next does not occur. After this, processing advances to step S104.

FIG. 19B is a flowchart for write processing within the HDD 900 for FIGS. 18A-18D. Note, because the contents of processing of step S201-step S202, step S210-step S211, step S206-step S209 of FIG. 19B is the same as the processing of step S201-step S202, step S210-step S211, and step S206-step S209 of FIG. 8B, a detailed explanation will be omitted.

Note, dummy data is added to erasure target data in this embodiment as shown in FIG. 18C. For this reason, in the processing of step S211, even if overwriting a corresponding area using the SMR method, by rewriting dummy data that is one track behind, rewriting of required data that is further back is prevented. Also, at step S201, in a case that erasure flag data is not detected, a normal write command is selected, and writing of data to an optional vacant area is performed through normal write processing (step S210-step S211).

(Data Deletion Processing)

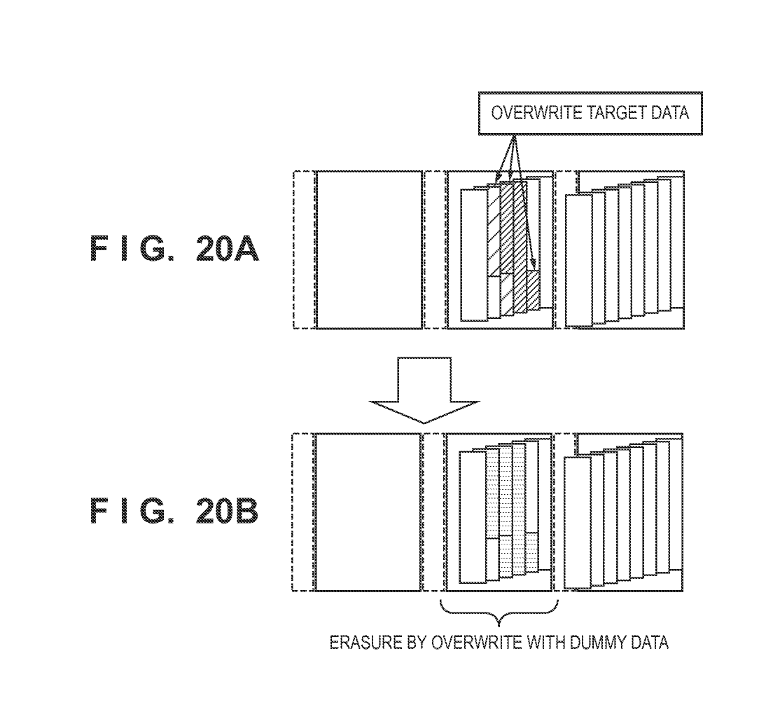

FIGS. 20A and 20B are conceptual diagrams for explaining deletion processing of data according to the fourth embodiment. FIG. 20A shows a state in which erasure target data and dummy data that is attached to it is written, and in which further data has been written to a particular zone of the HDD 900, by the processing of FIGS. 19A and 19B. Also, FIG. 20B shows a state in which overwrite erasure is applied to erasure target data for that zone.

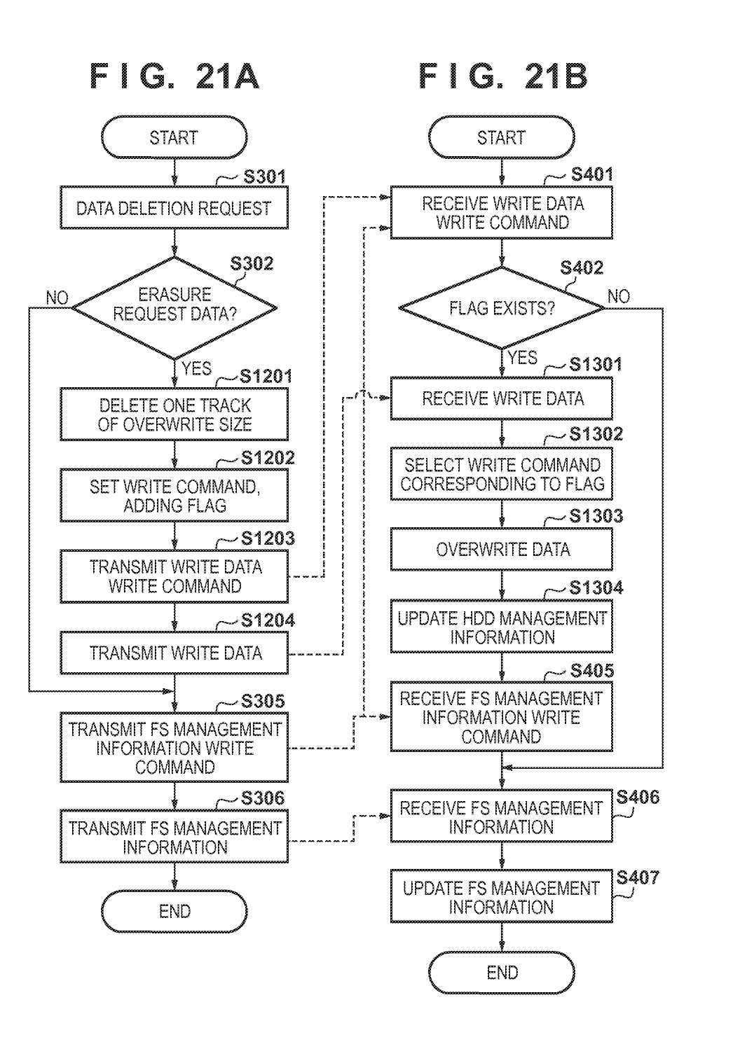

FIGS. 21A and 21B show processing of each of the controller unit 400 and the HDD 900 for the data deletion processing according to the embodiment, and the broken line arrows in FIGS. 21A and 21B show transmission/reception of data between the subjects. FIG. 21A is a flowchart for overwrite erasure processing within the controller unit 400 that is connected to the HDD 900 in FIGS. 20A and 20B. Note, since the content of processing of step S301-step S302 and step S305-step S306 of FIG. 21A is the same as that of step S301-step S302 and step S305-step S306 of FIG. 9A, a detailed explanation is omitted.

In the case that write data is erasure target data (Yes at step S302), the CPU 401, at step S1201, deletes one track worth of size for a size already written in the file system. In other words, the size that is deleted corresponds to the size of dummy data that is added at step S1101 of FIG. 19A. At this time, the CPU 401 holds a size of one track that corresponds to the connected HDD in the device beforehand, and performs a determination as to a size of a one track by using this.

At step S1202, the CPU 401, for a data write instruction that is transmitted to the HDD 900 through the storage controller 412, sets a value that is defined in advance as erasure flag data, in a predetermined area provided within the instruction. For step S1203, the CPU 401 transmits the write data write command that was set at step S1202 to the HDD 900. Furthermore, at step S1204, the CPU 401 transmits write data to the HDD 900. Since the same data packet as is shown in FIG. 10A of the first embodiment is used as an example of a write command, a detailed explanation has been omitted. After this, processing advances to step S305.

FIG. 21B is a flowchart for showing an overwrite erasure processing flow within the HDD 900 for FIGS. 20A and 20B. Note, since the content of the processing of step S401-step S402 and step S405-step S407 of FIG. 21B is the same as that of step S401-step S402 and step S405-step S407 of FIG. 9A, a detailed explanation is omitted.

In the case that erasure flag data is not detected (Yes at step S402), at step S1301 the HDD controller 901 receives write data of data that was transmitted from the controller unit 400 via the host I/F 902 at step S1204. At step S1302, the HDD controller 901 selects a write command corresponding to the erasure flag data. Here, a write command corresponding to the overwrite erasure mode is selected.

At step S1303, the HDD controller 901, executes an overwrite of data that is written. Note, in this embodiment, the data size of the erasure target data becomes smaller by an amount of the dummy data at the controller unit 400. For this reason, when executing overwriting, an adjacent track becomes dummy data, and overwriting that affects data that is further back is not performed.

At step S1304, the HDD controller 901 performs updating of storage location address information for an address that was written at step S1303 in the HDD management information. After this, processing advances to step S405.

By the above, because one track of extra data is written after the erasure target data, overwriting can be executed on an SMR method HDD. For this reason, it is possible for an SMR method HDD to achieve performance as if erasure processing were performed on a conventional type of HDD.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-022782, filed Feb. 7, 2014, which is hereby incorporated by reference herein in its entirety.

What is claimed is:

1. An information recording apparatus for recording data in a magnetic recording medium by a shingled write method, the apparatus comprising:
a setting unit configured to set, when the data is recorded in the magnetic recording medium, whether or not the data is data of a predetermined type; and
a management unit configured to, in a case where the data is the data of the predetermined type, record the data in an unused area out of a plurality of areas that comprise in the magnetic recording medium, and manage that the data of the predetermined type is recorded in that area, wherein
the management unit, in a case where the data of the predetermined type is deleted from the magnetic recording medium, deletes the data of the predetermined type, and manages the area to which the data of the predetermined type was recorded as an unused area.

2. An information recording apparatus for recording data in a magnetic recording medium by a shingled write method, the apparatus comprising:
a setting unit configured to set, when the data is recorded in the magnetic recording medium, whether or not the data is data of a predetermined type; and
a management unit configured to, in a case where the data is the data of the predetermined type, record the data in any area of a plurality of areas that comprise in the magnetic recording medium, and to manage such that an addition of further data to the area, to which the data of the predetermined type is recorded, is prohibited, wherein
the management unit, in a case where the data of the predetermined type is deleted from the magnetic recording medium, deletes the data of the predetermined type, and permits an addition of further data to the area to which the data of the predetermined type was recorded.

3. An information recording apparatus for recording data in a magnetic recording medium by a shingled write method, the apparatus comprising:
a setting unit configured to set, when the data is recorded in the magnetic recording medium, whether or not the data is data of a predetermined type; and
a management unit configured to, in a case where the data is the data of the predetermined type, add dummy data of a predetermined amount to the data of the predetermined type, and record in any area of a plurality of areas that comprise in the magnetic recording medium, and to manage that the data of the predetermined type is recorded in that area.

4. The information recording apparatus according to claim 3, wherein the area in which the data of the predetermined type is recorded is an unused area out of the plurality of areas that comprise in the magnetic recording medium.

5. The information recording apparatus according to claim 4, wherein the management unit controls a size of the dummy data so that a sum of a size of the data of the predetermined type and a size of the dummy data of the predetermined amount becomes a size of the area in which the data of the predetermined type is recorded.

6. The information recording apparatus according to claim 3, wherein the management unit, in a case where the data of the predetermined type is deleted from the magnetic recording medium, deletes the dummy data of the predetermined amount as well.

7. The information recording apparatus according to claim 3, wherein the management unit controls a size of the dummy data of the predetermined amount so that when the data of the predetermined type and data added thereafter is recorded in the area, an overlapping of data, due to the shingled write method, does not occur between this data.

8. The information recording apparatus according to claim 7, wherein the size of the dummy data of the predetermined amount is a size for one track in the area.

9. The information recording apparatus according to claim 7, wherein the management unit, in a case where the data of the predetermined type is deleted from the magnetic recording medium, does not delete the dummy data of the predetermined amount.

10. The information recording apparatus according to claim 1, wherein the management unit, in a case where the data of the predetermined type is deleted, deletes the data of the predetermined type by overwriting with dummy data.

11. The information recording apparatus according to claim 10, wherein the setting unit further sets at least one of a type of dummy data that is used and a number of times that overwriting is performed when the data of the predetermined type is deleted.

12. The information recording apparatus according to claim 1, wherein
a write instruction when data is recorded in the magnetic recording medium is defined based on a specification of SATA or ATA, and
information set by the setting unit is set in a features register in the specification of SATA or ATA.

13. The information recording apparatus according to claim 1, wherein the data of the predetermined type is spool data or a temporary file.

14. A method of controlling an information recording apparatus for recording data in a magnetic recording medium by a shingled write method, the method comprising:
a setting step of setting, when the data is recorded in the magnetic recording medium, whether or not the data is data of a predetermined type; and
a management step of, in a case where the data is the data of the predetermined type, recording the data in an unused area out of a plurality of areas that comprise in the magnetic recording medium, and managing that the data of the predetermined type is recorded in the area, wherein
in the management step, in a case where the data of the predetermined type is deleted from the magnetic recording medium, deletes the data of the predetermined type, and manages the area to which the data of the predetermined type was recorded as an unused area.

15. A method of controlling an information recording apparatus for recording data in a magnetic recording medium by a shingled write method, the method comprising:
a setting step of setting, when the data is recorded in the magnetic recording medium, whether or not the data is data of a predetermined type; and
a management step of, in a case where the data is the data of the predetermined type, recording the data in any area of a plurality of areas that comprise in the magnetic recording medium, and managing such that an addition of further data to the area, to which the data of the predetermined type is recorded, is prohibited, wherein
in the management step, in a case where the data of the predetermined type is deleted from the magnetic recording medium, the data of the predetermined type is deleted, and an addition of further data to the area to which the data of the predetermined type was recorded is permitted.

16. A method of controlling an information recording apparatus for recording data in a magnetic recording medium by a shingled write method, the method comprising:
a setting step of setting, when the data is recorded in the magnetic recording medium, whether or not the data is data of a predetermined type; and
a management step of, in a case where the data is the data of the predetermined type, adding dummy data of a predetermined amount to the data of the predetermined type, and recording in any area of a plurality of areas that comprise in the magnetic recording medium, and managing that the data of the predetermined type is recorded in that area.

17. A non-transitory computer-readable storage medium storing a program for causing a computer to function as each of the units of the information recording apparatus according to claim 1.
